(19) United States
(12) Patent Application Publication
(10) Pub. No.: US 2004/0246840 A1
(43) Pub. Date: Dec. 9, 2004

(54) Automatic parameter recording

(76) Inventors: Bernd Plagemann, Munchen (DE); Nimish Raipurohit, Karnataka (IN); Sandeep Katoch, Karnataka (IN)

Correspondence Address: Siemens Corporation, Intellectual Program Department, 170 Wood Avenue South, Iselin, NJ, 08830, US

(21) Appl. No.: 10/493,253

(22) PCT Filed: Aug. 30, 2002
(86) PCT No.: PCT/EP02/09691

(30) Foreign Application Priority Data
Oct. 19, 2001 (EP) 01124998.4

(51) Int. Cl. G11B 5/09

(52) U.S. Cl. 369/47.23; 369/53.31

(57) ABSTRACT

The invention relates to a method and a system for the partial automatic recording of parameter values for parameters, necessary for particular processes, which provide telecommunication services. A definition mask is used, from which a recording mask is automatically generated, which is suitable for the recording of the parameter values. The recording mask is process-specific and embodied such that inconsistencies with regard to the values are excluded, whereby the value of a parameter used by several processes need only be input once.

### CROSS REFERENCE TO RELATED APPLICATIONS

This application is the US National Stage of International Application No. PCT/EP02/09691, filed Aug. 30, 2002 and claims the benefit thereof. The International Application claims the benefits of European application No. 01124998.4 filed Oct. 19, 2001, both of the applications are incorporated by reference herein in their entirety.

### FIELD OF INVENTION

The invention relates to a method and a system for recording characteristic quantities, preferably parameters, which are processed by a plurality of processes and which can have mutual dependencies.

The invention relates in particular to the automatic recording of parameters in a distributed system comprising software-based components and applications, preferably for the requesting and/or provision of services in the field of telecommunications technology.

### BACKGROUND OF INVENTION

In a distributed system comprising different software applications which provide, for example, certain services to a user of a telecommunications device or network, parameters must be recorded for the respective applications. Different applications require different parameters which have to be input into the system. In this process it frequently happens that the parameter sets for the individual applications coincide, with the result that a parameter is therefore used and processed by a plurality of applications.

However, since parameter recording in particular, when it is done manually, is an error-prone process, an incorrect parameter specification can sometimes result in serious consequential errors which are often difficult to trace and therefore to remove.

A largely automated recording of characteristic quantities which are used by different processes is therefore desirable.

With existing systems from the prior art, parameters were in each case recorded separately for each application package via a specific input mask of a user interface. This meant that the system administrator responsible had to open very many input masks of this type and there was the further disadvantage that many parameters have to be input several times because they are used by different applications. This redundant procedure increased the probability of errors with known systems.

A further disadvantage lay in the fact that a large number of qualified personnel (administrators) were necessary in order to complete the entire operation of making services available and consequently also of recording parameters, since the process of recording the parameters on the one hand and the process of inputting the parameter values on the other hand were interleaved.

### SUMMARY OF INVENTION

The object of the invention is therefore to disclose a way which allows automatic and centralized recording of characteristic quantities for a set of processes and which excludes a redundant input of these characteristic quantities.

The object is achieved by a method of the type referred to in the opening remarks, which comprises the following method steps:

Record the characteristic quantity (quantities) for each process from the set of processes

Determine the interdependencies between the characteristic quantities, preferably determining multiply processed characteristic quantities which are processed by a plurality of processes and/or by one process a plurality of times

Automatically generate an entry mask for each individual process based on the recorded characteristic quantities and/or based on the determined interdependencies, and

Record the values of the characteristic quantities using the generated entry masks,

whereby the entry masks are generated such that the values of the characteristic quantities recorded over the totality of all generated entry masks are recorded only once in each case and/or the values of the characteristic quantities processed a plurality of times are recorded automatically.

An achievement of the object as claimed in claim 14 consists in a system for recording values of characteristic quantities which are processed by a set of processes, wherein the processes exhibit interdependencies with regard to the characteristic quantities used by them, comprising:

a recording module which is intended for recording the characteristic quantity (quantities) for each process from the set of processes,

a linkage module which is intended for determining the interdependencies between the characteristic quantities, preferably for determining multiply processed characteristic quantities which are processed by a plurality of processes and/or by one process a plurality of times,

a generation module which is intended for automatically generating one entry mask for each individual process based on the recorded characteristic quantities and/or based on the determined interdependencies,

whereby the values of the multiply processed characteristic quantities are automatically recorded via the entry mask and whereby the entry masks are generated such that the values of the characteristic quantities recorded over the totality of all generated entry masks are recorded only once in each case.

In the preferred embodiment of the invention the method relates to the automatic recording of parameters for a plurality of applications in the field of telecommunications and/or overall to the process of providing telecommunications services.

Alternative potential applications of the method according to the invention lie in the field of process control and automation technology. Here, too, certain processes (in production, for example) require some common and some different parameters. So that these parameter values do not have to be recorded or entered redundantly, centrally controlled, automated recording is possible according to the invention. For all parameters used in common or shared by a number of applications, the associated values are recorded once only and filled out automatically in all other recording operations by copying of the respective contents of the already recorded parameter.

The set of applications is defined and the parameters required for each individual application are determined. This result is then subjected to a processing operation, whereby an application-specific entry mask is generated from the set of required parameters for the set of applications, via which mask the parameter values can then be recorded at a later time. This operation preferably executes automatically.

In an alternative embodiment provision is, however, made for a manual intervention on the part of the user to be allowed here cumulatively so that a specific knowledge of the links between the parameters can also be taken into account during the generation of the entry masks.

A significant advantage of the method described here is to be seen in the fact that the process for recording parameter values runs in a plurality of phases and can be subdivided in particular into two phases which presuppose a different degree of system knowledge. According to the invention the recording process is subdivided such that in a first phase system know-how with regard to the interdependencies between the required parameters is necessary. It has to be decided here, for example, whether a required parameter is predominantly optional or mandatory during processing in a specific application.

On the basis of this data there is created for each process a specific entry mask via which its associated parameter values will be recorded at a later time.

In a second phase the parameter values required for the set of applications can then be queried automatically or read out automatically through access to further data records. No system knowledge is required in this second phase.

The method or system according to the invention is preferably structured in such a way that the first and second phase can run totally decoupled from each other. This means that the phases can be completed at different times and by different system domains of a distributed system.

By subdivision into phases it is advantageously possible to assign different user profiles. In the first phase it is necessary to have an administrator with system knowledge who knows the links and/or interdependencies between the services and processes with their associated parameters, whereas in the second phase it is possible to assign a user who possesses no specific system knowledge. The user has simply to specify the values requested via the entry mask. In so doing he needs to enter the parameter values which are processed by a plurality of processes only once, with the result that inconsistent inputs can be avoided.

During the creation of the parameter recording template, every possible combination of service applications is taken into account so that all the parameter values necessary for them are recorded and will be available later.

For the creation of the parameter recording template in the first phase it is provided that the administrator is guided—partly interactively—by the system. For this, a list of possible services is provided which require a specific parameter occupancy. From this list the operator must now simply select the services required for the respective application or situation. Thereupon, certain parameters to be recorded are proposed to him, which in an advantageous embodiment of the invention he can confirm or replace by others and/or supplement. After termination of this definition step an individual entry mask is created automatically and advantageously uniformly and centrally by the system for one process in each case, which mask will then be available at any points and can also be filled out by different system units or different users.

A particular advantage is to be seen in the fact that different users can also input the necessary parameter values in the second phase and that alternatively and/or cumulatively automatic recording is possible through access to corresponding data or data records of the system without inconsistencies being able to occur with regard to the recorded parameters.

The system described here is a generic embodiment, so that the set of processes can be expanded dynamically and in modular fashion, reduced, or modified in some other way without the system or the method needing to be modified in principle. In a preferred embodiment, a change to the set of applications is made via a specific user mask.

It is also provided that the processes, the parameters necessary for them, and their associated interdependencies are stored in a database. The parameters which are used collectively by a plurality of processes can then be determined by means of an access to the database.

According to the preferred embodiment the entry masks are generated such that they indicate which parameters are necessary in principle for a specific process, but in this case provide no means of inputting their associated values if these parameter values have already been determined on the basis of other processes.

The method is preferably designed in such a way that the intersection of the values to be input by the user is empty over the set of all the entry masks.

In the preferred embodiment the process relates to an application which provides a customer specific telecommunications services and for its part refers to specific characteristic quantities such as, for example, parameters, parameter values and/or other data or data records.

According to an alternative achievement of the object, a storage medium is provided which is intended for storing the above described, computer-implemented method and can be read by a computer.

The above described embodiments of the method according to the invention can also be implemented as a computer program product which has a computer-readable medium having computer program code means and with which, after the loading of the computer program, the computer is caused by the program to perform the above described method according to the invention.

Additional advantageous embodiments can be derived from the subclaims.

### BRIEF DESCRIPTION OF THE DRAWINGS

In the following detailed description of the figures, exemplary embodiments (which are not to be understood as restricting the inventive scope) are discussed together with their features and further advantages with reference to the drawing, in which:

FIG. 1 shows a schematic diagram representing a method according to the invention,

FIG. 2 is a flowchart of the method, and

FIGS. 3a and 3b show a schematic representation of a definition mask and an entry mask.

### DETAILED DESCRIPTION OF INVENTION

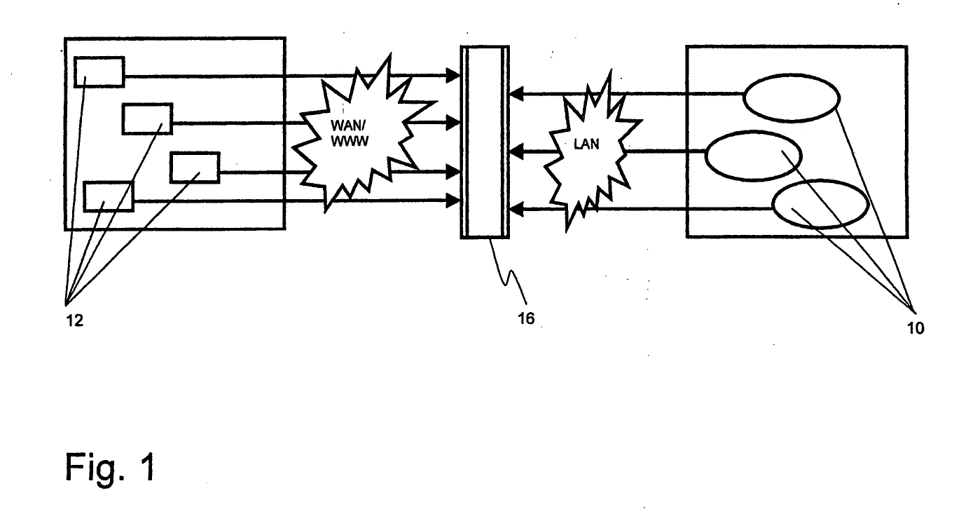

The basic scenario of the method according to the invention is presented in FIG. 1. A customer requests for example certain services of his telecommunications device which require the execution of specific technical processes 10 and for their part refer to a set of partly different and partly identical parameters 12 whose values 14 are to be recorded. The recording of the parameter values 14 is centrally controlled such that a parameter value 14 of a parameter 12 which is used by a plurality of processes 10 is recorded only once in each case and otherwise is copied automatically.

It is also provided that the recording of the parameter values 14 is performed by a central system 16 which can provide request profiles and specific masks 18, 20 for recording parameter values 14 of user interfaces via a data communication network, in particular a WAN or a LAN.

As the set of processes 10 and the set of parameters 12 processed by them are furnished centrally, it is possible to avoid a redundant input of parameter values 14.

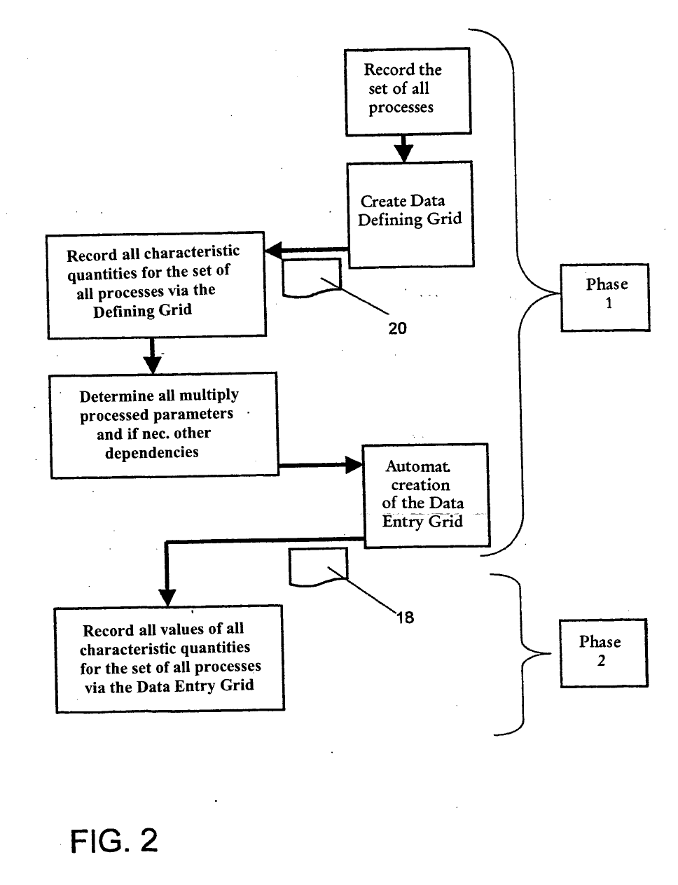

As shown in FIG. 2, the procedure according to the invention is subdivided into two phases: a definition phase, which requires a knowledge of the system, in particular a knowledge of the interrelationships between the individual processes 10 with their parameters 12, and a recording phase, which can be performed by any operating staff since the necessary inputs to be made are presented in advance via an entry mask 18. In the first definition phase it is recorded which service is based on which parameters 12 and in what way.

In the preferred embodiment of the invention a definition mask 20—known as a Data Definition Grid—is also used here, said mask proposing a set of selectable parameters 12 for a set of services or processes 10. This proposal can, however, be modified or added to as desired. Then the interdependencies of the respective processes 10 with their associated parameters 12 are determined. In particular it is recorded here which parameters 12 are processed a plurality of times. On the one hand this can happen such that one and the same parameter 12 is processed by a plurality of different processes 10. On the other hand it can also be the result of the parameter 12 being used by one process 10 a plurality of times. In these cases the corresponding value 14 is recorded only once in each case inside the system.

After the parameters 12 and their interdependencies have been determined, an entry mask 18, known as the Data Entry Grid, is now automatically created iteratively for all processes 10 from the set of processes.

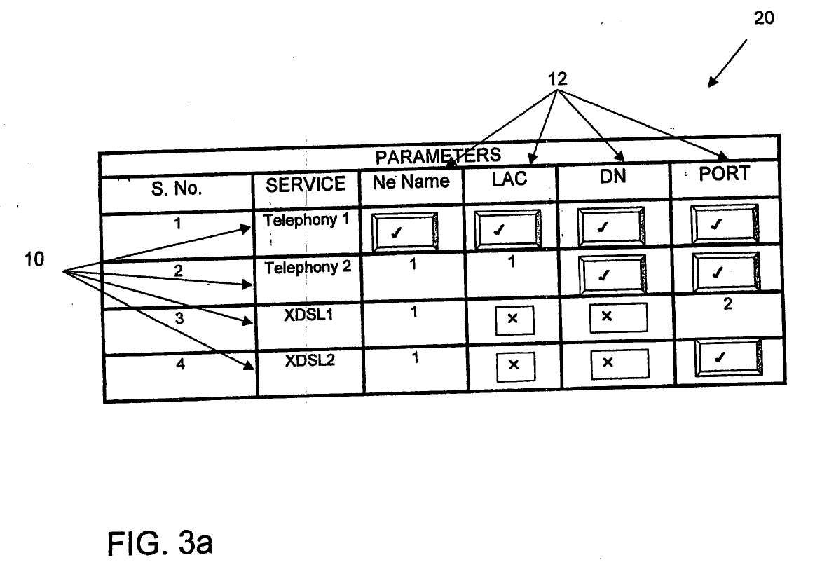

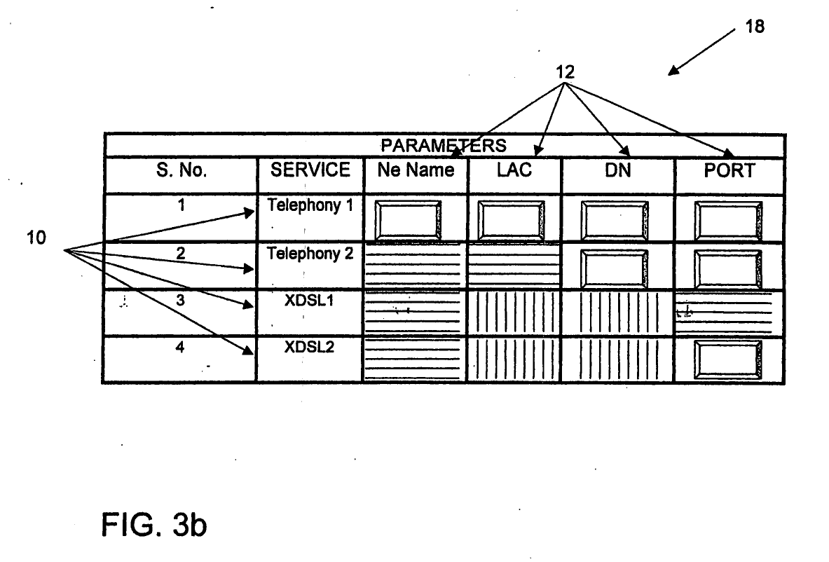

An example of a definition mask 20 and an entry mask 18 is represented schematically in FIGS. 3a and 3b respectively. In the preferred embodiment both are created in a tabular format. It is, however, also possible to choose a different data structure and where necessary also include additional data records in it.

It can be seen from the different background of the individual fields in the table in FIG. 3b that the entry mask 18, while displaying all the necessary parameter values 14 to the user, only provides an input option for those whose values 14 have not already been recorded elsewhere. All the required, but already recorded values are indicated here by horizontal stripes. The values which are not necessary in each case are marked by vertical stripes. The two masks 18, 20 form part of user interfaces.

In the first phase an administrator specifies with the aid of the definition mask 20 which parameters 12 are to be selected for a particular service or process 10, which are shared by other processes 10, and in what way they are to be used in the respective application. For example, the parameter “Port” can be used to identify the subscriber line for the use of voice services and for the use of DSL data services. Any valid combination of services can be selected here. In order to add a further service to the definition mask 20, the administrator must choose one or more services which are offered to him via a selection (dropdown) list (e.g. telephony or xDSL). This is included as a new row entry in the generated table-like definition mask 20. Depending on the number of the parameters 12 required for this service, a corresponding number of columns is added.

FIG. 3a shows that for the service “Telephony 1” a check box is provided under the parameter “Ne Name” in order to indicate that this parameter value 14 has to be entered at a later time either by manual input or by reading in following access to other data structures of the system. For all other services shown in this figure, the definition mask 20 contains the number “1” as the entry relating to the parameter “Ne Name” in order to indicate that the value does not need to be entered later, but can be generated automatically from the corresponding field of the first service. This is executed by copying of the respective contents. The same applies to the parameter “LAC”, which likewise only needs to be copied from the first entry for the service “Telephony 2”. In contrast, this parameter is not required for the two next services. This is indicated by a cross in FIG. 3a.

As already mentioned above, the respective services can differ not only in terms of the parameters 12, but also in terms of their usage. Thus, the services “Telephony 1” and “Telephony 2” each require different uses of the parameter “Port”, which means that this parameter has to be input for both services.

The definition mask 20 is structured such that the entry mask 18 can be derived from it automatically.

Because of the centralized control and the generation of the masks it is possible to provide for as few interactive inputs on the part of a user as possible, in order to eliminate potential sources of error.

The first phase is completed with the creation of the entry mask 18. A user can now use the entry mask 20 at any later time to input all the necessary parameter values 14 and is guided interactively while so doing. In particular the user does not have to be concerned about any inconsistencies which can arise for example as a result of the fact that different values 14 exist for one and the same parameter 12. An error of this kind is ruled out by the procedure according to the invention.

In an alternative embodiment of the invention the system additionally resorts to a verification module which is intended to check inputs made in the entry mask 18 in relation to the parameter values 14 with regard to their validity. Thus, for example, an error message is displayed immediately after an incorrect input if an invalid alphanumeric combination has been entered here.

1.-15. (cancelled)

16. A method for recording values of characteristic quantities which are processed by a set of processes that exhibit interdependencies with regard to the characteristic quantities, the method comprising:
recording a characteristic quantity for each process from the set of processes;
determining the interdependencies between the characteristic quantities;
automatically generating one entry mask for each individual process based on the recorded characteristic quantities and/or based on the determined interdependencies; and
recording the values of the characteristic quantities using the generated entry masks,
wherein
the entry masks are generated such that the values of the characteristic quantities recorded over the totality of all generated entry masks are recorded only once in each case and/or the values of the characteristic quantities processed a plurality of times are recorded automatically.

17. The method according to claim 16, wherein the set of processes can be modified dynamically without the need for the method to be subjected to a change.

18. The method according to claim 16, wherein the recording of the characteristic quantities for all processes from the set of processes is performed using a definition mask.

19. The method according to claim 16, wherein the characteristic quantities mandatorily required for the respective process are recorded.

20. The method according to claim 16, wherein the optional characteristic quantities for the respective process are recorded.

21. The method according to claim 16, further comprising:
recording a processing vector which specifies how the recorded characteristic quantities of the respective process are processed or used.

22. The method according to claim 16, wherein the entry mask is process-specific.

23. The method according to claim 16, wherein the entry masks for the set of processes are designed such that the values of multiply processed characteristic quantities are recorded only once.

24. The method according to claim 16, wherein the entry masks are generated automatically.

25. The method according to claim 16, wherein during the generation of the entry masks use is made of a verification module which comprises a check on the input data and/or values with regard to their validity.

26. The method according to claim 16, wherein during the generation of the entry masks the structure of the processes and/or the interdependencies of the recorded characteristic quantities between the processes are processed.

27. The method according to claim 16, wherein the characteristic quantities and/or the values of the characteristic quantities are recorded centrally.

28. The method according to claim 16, wherein the values of the multiply processed characteristic quantities are recorded automatically in that a value determined via the entry mask is copied for the other characteristic quantities.

29. A system for recording values of characteristic quantities processed by a set of processes that exhibit interdependencies with regard to the characteristic quantities, the system comprising:
a recording module for recording a characteristic quantity for each process from the set of processes;
a linkage module for determining the interdependencies between the characteristic quantities; and
a generation module for automatically generating one entry mask for each individual process based on the recorded characteristic quantities and/or based on the determined interdependencies, wherein
the values of the multiply processed characteristic quantities are automatically recorded via the entry mask and wherein the entry masks are generated such that the values of the characteristic quantities recorded over the totality of all generated entry masks are recorded only once in each case.

30. The system according to claim 29, wherein the set of processes can be dynamically modified as desired without any need for the system to be redesigned.

31. The method according to claim 16, wherein determining the interdependencies between the characteristic quantities comprises determining multiply processed characteristic quantities which are processed by a plurality of processes and/or by one process a plurality of times.

32. The system according to claim 29, wherein the linkage module determines multiply processed characteristic quantities which are processed by a plurality of processes and/or by one process a plurality of times.
